(19) United States
(12) Patent Application Publication
(10) Pub. No.: US 2025/0382511 A1
(43) Pub. Date: Dec. 18, 2025

(54) EPOXY-BASED STRUCTURAL ADHESIVE CAPABLE OF CURING AT ROOM TEMPERATURE AND RAPID BONDING AND PREPARATION METHOD THEREFOR

(71) Applicant: Zhengzhou University, Zhengzhou (CN)

(72) Inventors: Yuhan LI, Zhengzhou (CN); Peixin NIU, Zhengzhou (CN); Jun ZHU, Zhengzhou (CN); Ailing SUN, Zhengzhou (CN); Liuhe WEI, Zhengzhou (CN); Zhiying ZHAO, Zhengzhou (CN); Yifang ZHAO, Zhengzhou (CN)

(21) Appl. No.: 18/943,718

(22) Filed: Nov. 11, 2024

(30) Foreign Application Priority Data
Jun. 12, 2024 (CN) 202410753304.9

(51) Int. Cl. C09J 163/00; C08K 3/011

(52) U.S. Cl. CPC C09J 163/00; C08K 3/011; C09J 2463/00

(57) ABSTRACT

The present disclosure relates to the technical field of epoxy-based structural adhesives, in particular to the field of IPC C09J163, and more specifically relates to an epoxy-based structural adhesive capable of curing at room temperature and rapid bonding and a preparation method therefor. The adhesive includes: an epoxy resin, a macromolecular polyol, an isocyanate, a glycerol carbonate, a polyamine curing agent, and a catalyst. In the present application, by using glycerol carbonate terminated polyurethane to achieve a toughening effect and using a polyamine as the rapid curing agent, an epoxy-based structural adhesive capable of curing at room temperature and rapid bonding is obtained. Not only is the problem of a low curing speed solved, but also high bonding strength after curing is ensured.

### CROSS-REFERENCE TO RELATED APPLICATIONS

The present application is based upon and claims priority to Chinese patent application No. 202410753304.9, filed on Jun. 12, 2024, the entire content of which is incorporated herein by reference.

### TECHNICAL FIELD

The present disclosure relates to the technical field of epoxy-based structural adhesives, in particular to the field of IPC C09J163, and more specifically relates to an epoxy-based structural adhesive capable of curing at room temperature and rapid bonding and a preparation method therefor.

### BACKGROUND

Structural bonding is a rigid demand in the industries of consumer electronics, automobiles, railways and underwater vehicles, aircraft and aviation, and these industries rely closely on structural adhesives capable of strongly fixing metals and polymer components. In addition to the prerequisite of high bonding strength, these industries increasingly require that superadhesives can realize rapid bonding without heat, in order to realize rapid production and convenient bonding of large components on site, such as assembly of electronic products on assembly lines, battery modules, wind turbine blades, and maintenance of large vehicles. At present, acrylic resins, epoxy resins and polyurethanes have been successfully developed into commercial structural adhesives. The polyurethane adhesives contain isocyanate release components and have slowly increased bonding strength, the acrylic adhesives inevitably include harmful volatile monomers that will give off unpleasant odors, and the epoxy adhesives usually need curing at high temperature. Therefore, it is of great significance and challenge to explore a next generation of structural adhesives that meet demands of current trends.

CN112011303B discloses an epoxy resin adhesive capable of curing at room temperature and having high temperature resistance, a preparation method therefor and use thereof. The epoxy resin adhesive includes a component A and a component B, wherein the component A includes an epoxy resin matrix and a high temperature resistant filler. The component B includes an epoxy resin curing agent and amino-containing carbborane. The amino-containing carbborane contains two amino groups, and the two amino groups are terminal groups of the amino-containing carbborane, respectively. The amino groups are directly connected to a carbboranyl group, or the amino groups are connected to the carbboranyl group through an aromatic hydrocarbon structure, a silyl, or a siloxy, respectively. The epoxy resin adhesive can be cured at room temperature, and a cured substance has good bonding strength. However, a curing process needs to last for 7 days, and the bonding strength is not higher than 16 MPa.

### SUMMARY

In a first aspect, the present disclosure provides an epoxy-based structural adhesive capable of curing at room temperature and rapid bonding, including: an epoxy resin, a macromolecular polyol, an isocyanate, a glycerol carbonate, a polyamine curing agent, and a catalyst.

The epoxy resin includes a bisphenol A type epoxy resin, a bisphenol F type epoxy resin, and other multi-functional aromatic epoxy resins.

Preferably, the bisphenol A type epoxy resin includes at least one of E51, E44, E55, and E42.

Preferably, the bisphenol A type epoxy resin includes at least one of the E51 and the E44.

The macromolecular polyol includes at least one of a polypropylene oxide polyol, a polyethylene oxide polyol, a polytetramethylene ether polyol, a polytrimethylene ether polyol, a polycarbonate polyol, a polyester polyol, a propylene oxide-ethylene oxide copolymer polyol, a propylene oxide-tetrahydrofuran copolymer polyol, and hydroxy-terminated polybutadiene.

Preferably, the macromolecular polyol has an average functionality degree of 2-3 and a number-average molecular weight of 500-5,000 g/mol.

Preferably, the macromolecular polyol includes a polytrimethylene ether diol and a polyether polyol 330N, and a molar ratio of the polytrimethylene ether diol to the polyether polyol 330N is (1.5-3):1.

The isocyanate includes at least one of toluene diisocyanate, 4-methoxy-1,3-phenyl diisocyanate, 4-isopropyl-1,3-phenyl diisocyanate, 1,4-tetramethylene diisocyanate, 1,6-hexamethylene diisocyanate, 1,10-decamethylene diisocyanate, 1,4-cyclohexyl diisocyanate, xylene diisocyanate, 4,4-methylenebis(cyclohexylisocyanate), 1,5-tetrahydronaphthalene diisocyanate, dicyclohexylmethane diisocyanate, and isophorone diisocyanate.

The polyamine curing agent includes at least one of phenolic amine, polyamide, and polyethyleneimine.

The polyamine curing agent includes the phenolic amine and the polyethyleneimine, and a mass ratio of the phenolic amine to the polyethyleneimine is (8-15):1.

Preferably, the polyamine curing agent includes the phenolic amine and the polyethyleneimine, and the mass ratio of the phenolic amine to the polyethyleneimine is (8-12):1.

Preferably, the phenolic amine has a trade name of T31 and is purchased from Baling Petrochemical Branch of China Petrochemical Group.

Preferably, the polyethyleneimine has a number-average molecular weight of 1,000-5,000, and further preferably, the polyethyleneimine has the number-average molecular weight of 1,200 and is purchased from Energy Chemical Company.

Preferably, the catalyst includes one or more of dibutyltin dilaurate, stannous octoate, dibutyltin bis(dodecylthio), dibutyltin diacetate, dialkytin dimaleate, and alkyltin dimercaptide.

A molar ratio of the macromolecular polyol, the isocyanate and the glycerol carbonate is 1:(1.5-2.2):(1.2-1.7).

Preferably, the molar ratio of the macromolecular polyol, the isocyanate and the glycerol carbonate is 1:(1.7-2.2):(1.3-1.7).

In a second aspect, the present disclosure provides a preparation method for an epoxy-based structural adhesive capable of curing at room temperature and rapid bonding, including the following steps:
S1, adding a macromolecular polyol, performing vacuum dehydration, and then adding an isocyanate and a catalyst for a reaction to obtain a prepolymer;
S2, adding a glycerol carbonate to the prepolymer for termination to obtain an intermediate; and
S3, mixing the intermediate with an epoxy resin, performing even stirring, and adding a polyamine curing agent for curing to obtain an adhesive.

A mass ratio of the intermediate to the epoxy resin is 1:(1.5-9).

Preferably, the mass ratio of the intermediate to the epoxy resin is 1:(2-5).

Further preferably, the mass ratio of the intermediate to the epoxy resin includes one of the following: 1:4, 3:7, 1:3, and 2:7.

The present application finds through research that when the mass ratio of the intermediate to the epoxy resin is 1:(1.5-9), an excellent bonding effect can be achieved, the shear strength after curing at room temperature can reach up to 20.4 MPa, and the peel strength can reach up to 7.02 kN/m2. The reasons may be that a tougher molecular structure is formed, and energy is dissipated through rearrangement of soft segments and dissociation of polyurethane hydrogen bonds. On the one hand, because of large steric hindrance of an aromatic ring structure and curing at room temperature, pure EP (epoxy resin) is difficult to form a dense crosslinked network. On the other hand, abundant hydrogen bonds produced by hydroxyl functional groups and π-π stacking of benzene rings limit the fluidity of chains. Therefore, the pure EP cannot resist a force, the energy is dissipated, and cracks are spread rapidly. Different from the pure EP, a molecular network with a higher crosslinking density can be established due to a branched topological structure of the soft segments and a faster reaction, which can resist an external force and improve the strength of a material. Meanwhile, separate crosslinking of the epoxy resin and highly branched glycerol carbonate terminated polyurethane (PUGC) promotes the conversion from chains with interpermeable molecules to an incompatible network, such that phase separation of the PUGC in the epoxy resin is induced, and a PUGC domain surrounded by an IPN shell is generated therefrom. Such phase separation can exist as a defect in the crosslinked network and is used as a stress concentration point under stress. The stress can be transferred to the PUGC aggregation domain through the IPN shell, and the stress is dissipated by rearrangement of the soft segments and dissociation of carbamate hydrogen bonds. Therefore, the crack spread direction is changed, and the crack path is increased, such that the toughness is improved.

In the present application, by mixing the branched glycerol carbonate terminated polyurethane (PUGC) as a toughening agent and using a polyamine as the rapid curing agent, an epoxy-based structural adhesive capable of curing at room temperature and rapid bonding is designed. By introducing a reasonable amount of the PUGC, the strength of the adhesive can be rapidly increased to about 16.0 MPa within 4 hours and is stabilized at about 21 MPa after more than 7 hours, which greatly exceeds the performance of commercial epoxy adhesives capable of curing at room temperature. A mechanism is as follows. On the one hand, the branched topological structure of the glycerol carbonate terminated polyurethane (PUGC) provides a possibility to make the glycerol carbonate and amino functional groups get close to each other, such that favorable conditions are created for kinetics of a ring-opening reaction without additional heating, and convenience is provided for rapid crosslinking and formation of abundant polyurethane and hydroxyl functional groups. On the other hand, asynchronous crosslinking of the epoxy resin and the PUGC promotes the conversion from polymer chains with interpermeable molecules to an immiscible network, such that phase separation of the PUGC in the epoxy resin is induced, and a resulting PUGC aggregation domain surrounded by the IPN shell effectively toughens the matrix. Secondly, the abundant dynamic hydrogen bonds of the polyurethane and hydroxyl functional groups and the elastic PUGC aggregation domain together dissipate the energy of shear stress, and the integrity of a bonding interface before an adhesive layer is torn is actively maintained, such that the strength of the adhesive is significantly improved. In addition, such adhesive can maintain a strong bonding state after long-term heat treatment and is at a level comparable to that of an original sample cured at room temperature.

A polymer dispersity index (PDI) of the intermediate is 1.8-2.8.

Preferably, the polymer dispersity index of the intermediate is 2-2.8.

### Beneficial Effects

1. In the present application, by using the glycerol carbonate terminated polyurethane to achieve a toughening effect and using a polyamine as the rapid curing agent, an epoxy-based structural adhesive capable of curing at room temperature and rapid bonding is obtained. Not only is the problem of a low curing speed solved, but also high bonding strength after curing is ensured, and the strength of the adhesive can be rapidly increased to about 16.0 MPa within 4 hours and is stabilized at about 21 MPa after more than 7 hours.

2. When the mass ratio of the intermediate to the epoxy resin is 1:(1.5-9), an excellent bonding effect can be achieved, the shear strength can reach up to 20.4 MPa, and the peel strength can reach up to 7.02 kN/m2.

3. The adhesive prepared in the present application can maintain a strong bonding state after long-term heat treatment and is at a level comparable to that of an original sample cured at room temperature.

4. The gel time of the adhesive prepared in the present application can be shortened to be within 150 minutes at the fastest, which can be shortened by twice compared with simple epoxy systems.

5. The adhesive prepared in the present application can withstand a variety of solvents and also has excellent bonding strength in a strong acid or strong alkali environment.

6. The adhesive prepared in the present application has surface energy similar to that of a steel plate, which can support better wetting between the adhesive and a substrate and avoid inward shrinkage. Lower interfacial tension is conducive to spreading the adhesive on a surface of the substrate and forming a uniform bonding layer, which facilitates interfacial adhesion and improves the strength of the adhesive.

7. The adhesive prepared in the present application can be used for bonding a variety of substrates, including steel plates, aluminum plates, epoxy resins, wood plates, PC, magnesium plates and titanium plates, and meanwhile, is also suitable for bonding between steel plates and a variety of other substrates.

### BRIEF DESCRIPTION OF THE DRAWINGS

FIG. 1 shows infrared spectra of intermediates in Examples 1-5.

FIG. 2 shows a shear strength histogram of steel plates bonded by adhesives in Example 3 and Comparative Example 5 at different curing times.

FIG. 3 shows electron microscope images of tensile cross sections of adhesives in Examples 1-5 and Comparative Example 5.

FIG. 4 shows rheological diagrams of adhesives in Example 1 (corresponding to a), Example 2 (corresponding to b), Example 4 (corresponding to c) and Example 5 (corresponding to d).

FIG. 5 shows rheological diagrams of adhesives in Example 1 and Comparative Example 5.

FIG. 6 shows the shear strength (a), peel strength (b), tensile strength (c) and fracture toughness (d) of steel plates bonded by adhesives in Example 3, Example 6, Example 7, Example 8 and Comparative Example 5.

### DETAILED DESCRIPTION OF THE EMBODIMENTS

### Examples 1-5

An epoxy-based structural adhesive capable of curing at room temperature and rapid bonding includes the components of: an epoxy resin, a macromolecular polyol, an isocyanate, a glycerol carbonate (GC), a polyamine curing agent, and a catalyst.

The epoxy resin is NPEL128 (E51) purchased from Nanya Electronic Materials (Kunshan) Co., Ltd.

The macromolecular polyol includes a polytrimethylene ether diol (Mn=1,000, purchased from Adamas of Guangzhou Haoyi Co., Ltd.) and a polyether polyol (trade name: 330N).

The isocyanate is dicyclohexylmethane diisocyanate (HMDI).

The polyamine curing agent includes phenolic amine and polyethyleneimine; the phenolic amine has a trade name of T31 and is purchased from Baling Petrochemical Branch of China Petrochemical Group; the polyethyleneimine has a number-average molecular weight of 1,200 and is purchased from Energy Chemical Company; and a mass ratio of the phenolic amine to the polyethyleneimine is 10:1.

The catalyst is dibutyltin dilaurate.

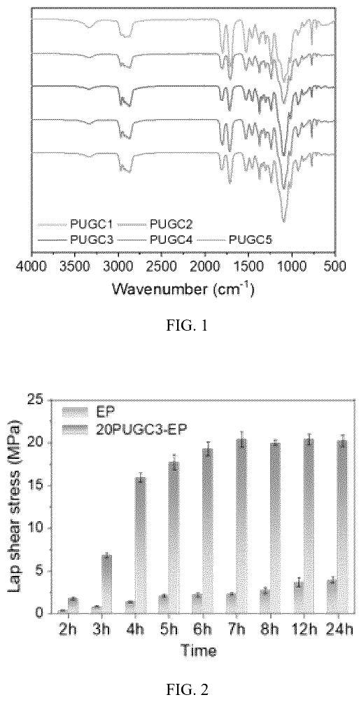

A preparation method for the epoxy-based structural adhesive capable of curing at room temperature and rapid bonding includes the following steps:
S1, subjecting a four-neck flask containing the macromolecular polyol to vacuum dehydration at 110° C. for 2 hours, then lowering the temperature to 80° C., adding the isocyanate, performing stirring for 1 hour, then adding the catalyst for prepolymerization for 3 hours, and after completion of the prepolymerization, obtaining a prepolymer;
S2, adding the glycerol carbonate to the prepolymer for termination, monitoring NCO characteristic peaks by FTIR (infrared spectroscopy, Bruck ALPHA II Fourier transform infrared spectrometer of Germany), and completing a reaction when the NCO peaks disappear to obtain an intermediate, named as PUGC, wherein infrared spectra are shown in FIGS. 1; and
S3, mixing the intermediate with the epoxy resin, performing even stirring in a vacuum defoaming mixer at 2,000 r/min, and adding the polyamine curing agent for curing to obtain the adhesive.

In Examples 1-5, a weight ratio of the intermediate to the epoxy resin is 1:4.

Intermediates in Examples 1-5 are named as PUGC1, PUGC2, PUGC3, PUGC4, and PUGC5, respectively. The raw material composition of the intermediates and the average functionality degree of the macromolecular polyol are shown in Table 1. Adhesives prepared in Examples 1-5 are named as 20PUGC1-EP, 20PUGC2-EP, 20PUGC3-EP, 20PUGC4-EP, and 20PUGC5-EP, respectively.

TABLE 1

| | | | Average | | |
|---|---|---|---|---|---|
| | | | functionality | | |
| | | | degree of a | | |
| | Polytrimethylene | | polyether | | |
| Intermediate | ether diol | 330N | polyol | HMDI | GC |
| PUGC1 | 0.050 mol | / | 2.000 | 0.100 mol | 0.100 mol |
| PUGC2 | 0.083 mol | 0.020 mol | 2.194 | 0.184 mol | 0.142 mol |
| PUGC3 | 0.037 mol | 0.020 mol | 2.351 | 0.110 mol | 0.083 mol |
| PUGC4 | 0.027 mol | 0.040 mol | 2.597 | 0.141 mol | 0.108 mol |
| PUGC5 | / | 0.030 mol | 3.000 | 0.135 mol | 0.180 mol |

### Examples 6-8

A specific embodiment is the same as that in Example 1. Differences are that the mass ratio of the intermediate to the epoxy resin in Examples 6-8 is shown in Table 2, wherein adhesives prepared in Examples 6-8 are named as 10PUGC3-EP, 30PUGC3-EP, and 40PUGC3-EP, respectively.

TABLE 2

| Adhesive | Intermediate (PUGC3) | Epoxy resin |
|---|---|---|
| 10PUGC3-EP | 10 | 90 |
| 30PUGC3-EP | 30 | 70 |
| 40PUGC3-EP | 40 | 60 |

### Comparative Example 1

An adhesive is Loctite-E00NS purchased from Henkel Loctite of China.

### Comparative Example 2

An adhesive is 3M-DP460 purchased from 3M of China.

### Comparative Example 3

An adhesive is Loctite-E20HP purchased from Henkel of China.

### Comparative Example 4

An adhesive is Pattex-PKME15C purchased from Henkel of China.

### Comparative Example 5

An epoxy-based structural adhesive capable of curing at room temperature and rapid bonding includes the components of: an epoxy resin and a polyamine curing agent.

The epoxy resin is NPEL128 (E51) purchased from Nanya Electronic Materials (Kunshan) Co., Ltd.

The polyamine curing agent includes phenolic amine and polyethyleneimine; the phenolic amine has a trade name of T31 and is purchased from Baling Petrochemical Branch of China Petrochemical Group; the polyethyleneimine has a number-average molecular weight of 1,200 and is purchased from Energy Chemical Company; and a mass ratio of the phenolic amine to the polyethyleneimine is 10:1.

A preparation method for the epoxy-based structural adhesive capable of curing at room temperature and rapid bonding includes the following steps: mixing the polyamine curing agent with the epoxy resin, performing even stirring in a vacuum defoaming mixer at 2,000 r/min, and performing curing to obtain the adhesive, named as EP.

### Performance Test Methods

1. The shear strength of steel plates bonded by the adhesives in Example 1-5 and Comparative Example 5 within different curing times was tested, and results are shown in FIG. 2.

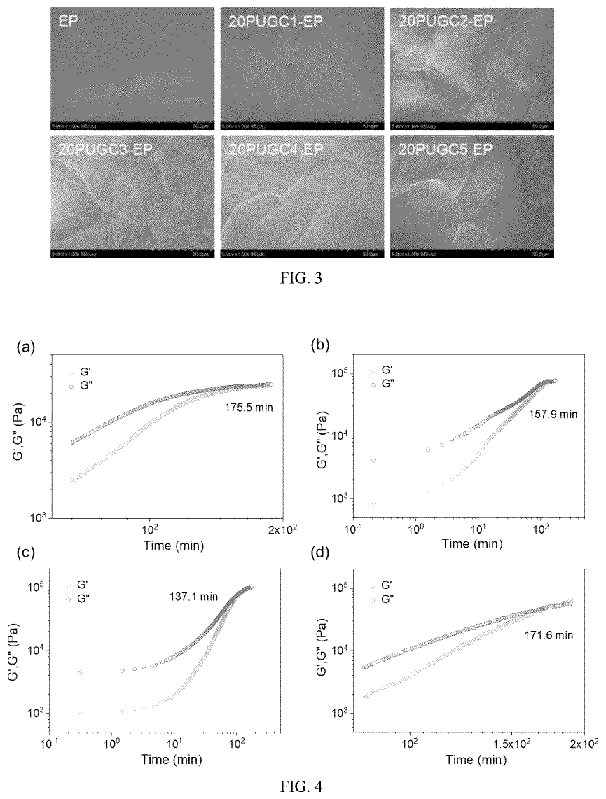

2. Electron microscope images (SEM) of tensile cross sections of the adhesives in Examples 1-5 and Comparative Example 5 were tested, and results are shown in FIG. 3.

3. The shear strength and peel strength of steel plates bonded by the adhesives in Example 1-5 and Comparative Example 5 were tested, and results are shown in FIG. 3.

4. The shear strength of steel plates bonded by the adhesives in Example 3, Comparative Example 1 and Comparative Example 2 within different curing times was tested, and results are shown in Table 4.

5. The shear strength of different substrates bonded by the adhesives in Example 3, Comparative Example 1, Comparative Example 3 and Comparative Example 4 was tested, and results are shown in Table 5.

6. The shear strength of different substrates bonded by the adhesive in Example 3 was tested, and results are shown in Table 6.

7. Environment/solvent resistance test: The shear strength of steel plates bonded by the adhesive in Example 3 after treatment in different environments/solvents for 24 hours was tested, and results are shown in Table 7.

8. High and low temperature stability: The shear strength of steel plates bonded by the adhesive in Example 3 after treatment in different environments for 7 days was tested, and results are shown in Table 8.

9. Gel time test: In Step S3, the intermediate was mixed with the epoxy resin, even stirring was performed in the vacuum defoaming mixer at 2,000 r/min, then the polyamine curing agent was added and quickly and evenly mixed, then a resulting mixture was placed on a rheometer for testing, and changes in energy storage modulus and loss modulus were recorded. Systems, such as EP, due to a long gel time, were timed after being fully and evenly stirred, and then tested after standing on the rheometer for a period of time. A final gel time was a sum of a test time and a standing time. A rheological test was carried out on a TA DHR-1 rheometer at a frequency of 10 Hz, and test results are shown in FIGS. 4-6.

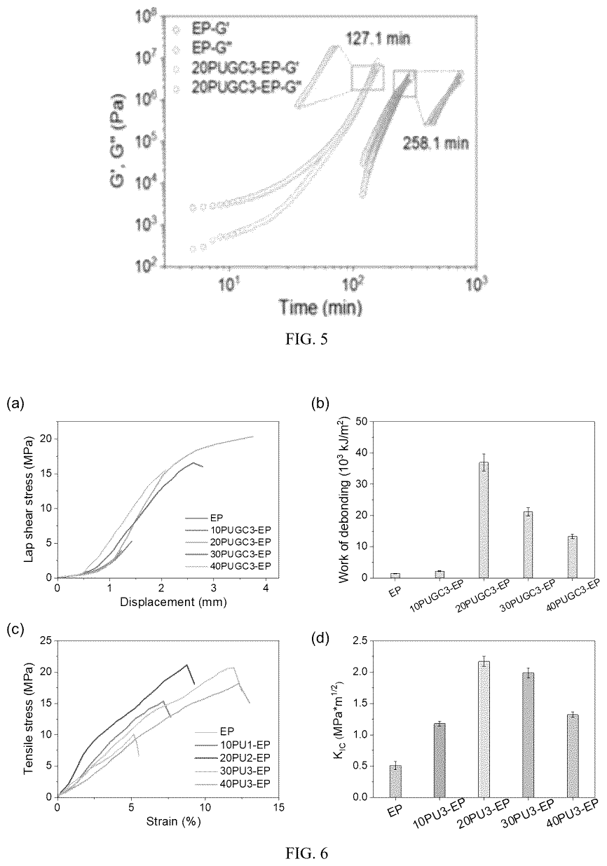

10. The shear strength (a), peel strength (b), tensile strength (c) and fracture toughness (d) of steel plates bonded by the adhesives in Example 3, Example 6, Example 7, Example 8 and Comparative Example 5 were tested, and test results are shown in FIG. 6.

A fracture toughness test was carried out at a rate of 10 mm/min according to an ASTM D5045/E399 test standard.

As can be seen from FIG. 3, a tensile fracture surface of the EP is very smooth and flat and shows the characteristic of brittle fracture, and a fracture surface of the 20PUGC3-EP becomes rough and shows obvious deflection of a crack path. In particular, the fracture surface of the 20PUGC3-EP has many rough grooves. The crack area is increased, and local shear yielding plastic deformation of the material is caused, which are evidence for energy dissipation of a molecular network under an external force.

As can be seen from FIG. 3, the introduction of PUGC plays an important role in improving the bonding strength. The pure EP has the shear strength of only 3.9 MPa and the bonding work of only 1.42 kN/m, and the addition of PU with different branching degrees improves the shear strength and bonding work to different degrees. As shown in FIG. 6, the 20PUGC3-EP has greatest improvement, and the shear strength (20.4 MPa) and the debonding work (37.02 kN/m) are increased by 423.1% and 250.7%, respectively.

### Performance Test Data

TABLE 3

| Adhesive | Shear strength (MPa) | Peel strength (103 kJ/m²) |
|---|---|---|
| EP | 3.915 | 1.425 |
| 20PUGC1-EP | 5.793 | 2.111 |
| 20PUGC2-EP | 12.505 | 8.133 |
| 20PUGC3-EP | 20.383 | 37.019 |
| 20PUGC4-EP | 16.328 | 13.519 |
| 20PUGC5-EP | 13.924 | 8.826 |

TABLE 4

| | Shear strength (MPa) | | | | | |
|---|---|---|---|---|---|---|
| Adhesive | 2 h | 4 h | 6 h | 8 h | 10 h | 12 h |
| 20PUGC3-EP | 1.77 | 15.91 | 19.28 | 19.96 | 20.08 | 20.37 |
| Loctite-E00NS | 0.56 | 1.32 | 1.41 | 1.56 | 2.88 | 4.47 |
| 3M-DP460 | 0.06 | 0.08 | 1.19 | 1.33 | 5.37 | 8.53 |

TABLE 5

| | Shear strength (MPa) | | | | | | |
|---|---|---|---|---|---|---|---|
| Adhesive/bonding | Steel | Aluminum | Epoxy | Wood | | Magnesium | Titanium |
| substrate | plate | plate | resin | plate | PC | plate | plate |
| 20PUGC3-EP | 20.38 | 12.04 | 11.29 | 10.42 | 7.05 | 6.30 | 4.90 |
| Loctite-E00NS | 6.68 | 2.00 | 7.18 | 7.27 | 3.21 | 2.82 | 2.21 |
| Loctite-E20HP | 7.48 | 2.41 | 6.46 | 4.68 | 2.19 | 3.28 | 4.90 |
| Pattex-PKME15C | 3.00 | 2.28 | 5.68 | 4.74 | 1.86 | 1.33 | 2.93 |

TABLE 6

| Bonding substrate | Shear strength (MPa) |
|---|---|
| Steel plate-aluminum plate | 16.67 |
| Steel plate-wood plate | 15.12 |
| Steel plate-epoxy resin | 12.85 |
| Steel plate-PC | 11.36 |
| Steel plate-magnesium plate | 6.39 |
| Steel plate-titanium plate | 5.77 |

TABLE 7

| Solvent/environment | Shear strength (MPa) |
|---|---|
| Air | 20.08 |
| Hexane | 20.14 |
| Water | 19.73 |
| 10 wt % sodium chloride aqueous solution | 19.08 |
| Alkaline solution with a pH value of 14 | 19.89 |
| (sodium hydroxide) | |
| Acidic solution with a pH value of 1 | 17.38 |
| (hydrochloric acid) | |
| Ethanol | 16.99 |
| Acetone | 16.13 |

TABLE 8

| | |
|---|---|
| Ambient temperature | Shear strength (MPa) |

| | | |
|---|---|---|
| 25° | C. | 20.33 |
| 120° | C. | 20.57 |
| −45° | C. | 20.28 |
| −45-120° | C. | 20.39 |

What is claimed is:

1. An epoxy-based structural adhesive capable of curing at room temperature and rapid bonding, comprising: an epoxy resin, a macromolecular polyol, an isocyanate, a glycerol carbonate, a polyamine curing agent, and a catalyst.

2. The epoxy-based structural adhesive capable of curing at room temperature and rapid bonding according to claim 1, wherein the epoxy resin comprises a bisphenol A type epoxy resin, a bisphenol F type epoxy resin, and other multi-functional aromatic epoxy resins.

3. The epoxy-based structural adhesive capable of curing at room temperature and rapid bonding according to claim 2, wherein the macromolecular polyol comprises at least one of a polypropylene oxide polyol, a polyethylene oxide polyol, a polytetramethylene ether polyol, a polytrimethylene ether polyol, a polycarbonate polyol, a polyester polyol, a propylene oxide-ethylene oxide copolymer polyol, a propylene oxide-tetrahydrofuran copolymer polyol, and hydroxy-terminated polybutadiene.

4. The epoxy-based structural adhesive capable of curing at room temperature and rapid bonding according to claim 1, wherein the macromolecular polyol has an average functionality degree of 2-3 and a number-average molecular weight of 500-5,000 g/mol.

5. The epoxy-based structural adhesive capable of curing at room temperature and rapid bonding according to claim 4, wherein the polyamine curing agent comprises at least one of phenolic amine, polyamide, and polyethyleneimine.

6. The epoxy-based structural adhesive capable of curing at room temperature and rapid bonding according to claim 5, wherein the polyamine curing agent comprises the phenolic amine and the polyethyleneimine, and a mass ratio of the phenolic amine to the polyethyleneimine is (8-15):1.

7. The epoxy-based structural adhesive capable of curing at room temperature and rapid bonding according to claim 6, wherein a molar ratio of the macromolecular polyol, the isocyanate and the glycerol carbonate is 1:(1.5-2.2):(1.2-1.7).
